(19) United States
(12) Patent Application Publication
(10) Pub. No.: US 2011/0231796 A1
(43) Pub. Date: Sep. 22, 2011

(54) METHODS FOR NAVIGATING A TOUCH SCREEN DEVICE IN CONJUNCTION WITH GESTURES

(76) Inventor: Jose Manuel Vigil, Buenos Aires (AR)

(21) Appl. No.: 13/029,110

(22) Filed: Feb. 16, 2011

Related U.S. Application Data
(60) Provisional application No. 61/304,972, filed on Feb. 16, 2010.
(60) Provisional application No. 61/439,376, filed on Feb. 4, 2011.

(51) Int. Cl. G06F 3/048

(52) U.S. Cl. 715/810

(57) ABSTRACT

A method for navigating a touch screen interface associated with a touch screen device including activating a first contact indicator within an object contact area on a touch screen interface of the touch screen device, in which the object contact area is configured to move within the touch screen interface in response to movement of the first contact indicator. The method further includes activating a point indicator within the object contact area away from the first contact indicator, in which the point indicator is configured to move within the object contact area in response to the movement of the first contact indicator. The method further includes positioning the point indicator over a target position associated with the touch screen interface and selecting a target information for processing, in which the target information is selected in reference to the target position.

### CLAIM OF PRIORITY UNDER 35 U.S.C. §119

The present application for patent claims priority to Provisional Application No. 61/304,972 entitled “METHODS FOR CONTROLLING A TOUCH SCREEN DEVICE POINTER ON A MULTI-TOUCH MOBILE PHONE OR TABLET IN CONJUNCTION WITH SELECTION. GESTURES AND CONTENT GESTURES” filed Feb. 16, 2010 and Provisional Application No. 61/439,376 entitled “METHODS FOR NAVIGATING A TOUCH SCREEN DEVICE IN CONJUNCTION WITH CONTENT AND SELECTION GESTURES” filed Feb. 4, 2011 both of which are hereby expressly incorporated by reference herein.

### TECHNICAL FIELD

The present description is related, generally, to touch screen devices, more specifically, to navigating touch screen devices in conjunction with gestures.

### BACKGROUND

Finger size affects many different aspects of operating a multi-touch device, such as performing basic operations as well as more complex operations like manipulating content. Fingers are inaccurate; they are not sharp and precise, and therefore do not make good pointing tools for a multi-touch surface. For example, compare the size of a finger with the size of a paragraph that is rendered on a web page of a cell phone. A normal finger would overlap all of the text if we placed it on top and, not only it is difficult to perform a selection, but it is also difficult to see the text beneath the finger. This problem of finger size also leads us to the second complication, being that there is still no efficient and simple method of selecting text on a mobile phone. Another issue that arises due to this inaccuracy is the amount of steps needed to complete simple operations. As there is no precision with our fingers, the steps necessary to do trivial operations are multiplied. The amount of steps can be reduced, however, if the first and most important problem is solved. Therefore, if we aim to have similar control with tactile computers as we currently have with PCs using a mouse, then this finger inaccuracy needs to be addressed. This is why a new approach is needed.

### SUMMARY

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

A method for navigating a touch screen interface associated with a touch screen device is offered. The method includes activating a first contact indicator within an object contact area on a touch screen interface of the touch screen device, the object contact area configured to move within the touch screen interface in response to movement of the first contact indicator. The touch screen device can be a multitouch touch screen device, a thin client electronic device, a touch screen cell phone a touch pad, or the like. The first contact indicator can be activated by making contact with the interface of the touch screen device with an object such as a finger or a pointing or touch device. In some embodiments the object can be sensed by an object sensing controller without making contact with the touch screen interface or screen. The object contact area may be referred to as the hit area.

The method also includes activating a point indicator within the object contact area away from the first contact indicator. The point indicator can be configured to move within the object contact area in response to the movement of the first contact indicator. The first contact indicator can be configured to move in response to movement of the object when in contact with the touch screen interface or when sensed by the objectsensing controller. The object contact area and the point indicator can be configured to move in conjuction with the movement of the first contact indicator. The point indicator may be illustrated by a cursor symbol such as an, arrow head, a hand symbol or a cross, for example. The first contact indicator may be illustrated by a marker, such as a black or white touch object mark. The method also includes positioning the point indicator or selection indicator over a target position associated with the touch screen interface. The method further includes selecting a target information for processing, in which the target information is selected in reference to the target position.

In some embodiments of the disclosure, activating the first contact indicator further comprises activating the first contact indicator in response to contacting the touch screen interface with an object. Activating the point indicator can include activating the point indicator in response to the activation of the first contact position indicator. The processing of the target information may include generating a gesture command signal on the touch screen interface with the object to activate processing of the target information. The gesture command signal may be a communication signal such as writing a letter with the object, such as an S for search, with the object. A processing controller may be configured to process the gesture command signal and generate a result to a user on the touch screen interface. The processing controller may be remotely located at a server, for example, or locally, in some implementations. Selecting the target information may further include, activating a second contact indicator, which can be activated by making contact with the screen with a second finger for example, and moving the second contact indicator to select the target information in reference to the target position. In order to select the target information, the second contact indicator can be moved angularly away or angularly toward the target position to select the target information in reference to the target position. The method also includes generating a geometrically shaped menu within the object contact area, in which the geometrically shaped menu can be configured to provide navigation features to the touch screen device cursor.

A apparatus for navigating a touch screen interface associated with a touch screen device is offered. The apparatus includes an object-sensing controller configured to activate the first contact indicator within the object contact area on a touch screen interface of the touch screen device. The object contact area can be configured to move within the touch screen interface in response to movement of the first contact indicator. The apparatus also includes a selection controller configured to activate the point indicator within the object contact area away from the first contact indicator. The point indicator can be configured to move within the object contact area in response to the movement of the first contact indicator. The point indicator indicator can be configured to be positioned over a target position associated with the touch screen interface to facilitate selection of target information for processing.

In some embodiments, the object sensing controller and the selection controller can be implemented in the same device. The object sensing controller and the selection controller can be remotely located, in a remote server for example, or located locally on the touch screen device. In some embodiments, the object-sensing controller can be configured to activate the first contact indicator in response to an object contacting the touch screen interface or sensing the object within a vicinity of the touch screen interface. The selection controller can be configured to activate the point indicator in response to the activation of the first contact indicator.

A processing controller can be configured to process the target information in response to a gesture command signal on the touch screen interface with the object. The processing controller, the object sensing controller and the selection controller, may be implemented or integrated in the same device. The processing controller, the object sensing controller and the selection controller may be implemented remotely, at a remote server, or locally at the touch screen device. The object sensing controller can be configured to activate a second contact indicator away from the first contact indicator. The second contact indicator can be configured to be moved around to select the target information in reference to the target position. The second contact indicator can be activated outside the object contact area. In some embodiments, the object-sensing controller can be configured to activate a geometrically shaped menu within the object contact area. The geometrically shaped menu can be configured to provide navigation features to the touch screen device.

An apparatus for navigating a touch screen interface associated with a touch screen device is offered. The apparatus includes a means for activating a first contact indicator within an object contact area on a touch screen interface of the touch screen device. The object contact area can be configured to move within the touch screen interface in response to movement of the first contact indicator. The apparatus also includes a means for activating a point indicator within the object contact area away from the first contact indicator.

The point indicator can be configured to move within the object contact area in response to the movement of the first contact indicator. The apparatus also includes a means for positioning the point indicator over a target position associated with the touch screen interface and a means for selecting a target information for processing, in which, the target information is selected in reference to the target position. The means for activating the first contact indicator further includes a means for activating a second contact indicator away from the first contact indicator. The second contact indicator can be configured to move to select the target information in reference to the target position.

### BRIEF DESCRIPTION OF THE DRAWINGS

For a more complete understanding of the present teachings, reference is now made to the following description taken in conjunction with the accompanying drawings.

FIG. 1A illustrates a screen shot of an example user interface of a touch screen device according to some embodiment of the disclosure.

FIG. 1B illustrates a navigation implementations with an object on the touch screen device according to some embodiments of the disclosure.

FIG. 1C illustrates a circular menu that can be configured to provide navigation features to the touch screen device cursor according to some embodiments of the disclosure.

FIG. 1D illustrates exemplary areas of interaction on the touch screen device according to some embodiments of the disclosure.

FIG. 1E shows some of the types of cursors that can be utilized as images for when different content types are identified by the point indicator 105 while it is been dragged according to some embodiments of the disclosure.

FIGS. 2A, 2B and 2C illustrate demonstrations of some functions of the touch screen device cursor according to some embodiments of the disclosure.

FIGS. 3A, 3B, 3C and 3D illustrate a touch screen device cursor navigation workflow in a sequence according to some embodiments of the disclosure.

FIG. 4A touch screen operation on the touch screen device 100 with the touch screen device cursor 104 according to some embodiments of the disclosure.

FIG. 4B illustrates a flowchart illustrating an exemplary single object interaction and two object interaction with the touch screen device cursor according to some embodiments of the disclosure.

FIGS. 5A, 5B and 5C illustrate touch screen device cursor navigation implementing a directional selection method according to some embodiments of the disclosure.

FIG. 5D illustrates an exemplary implementation of the touch screen device cursor according to some embodiments of the disclosure.

FIG. 5E illustrates an implementation of the directional selection of FIGS. 5A, 5B and 5C according to some embodiments of the disclosure.

FIG. 5F illustrates an implementation for selecting big chunks of operating system and/or application content 103 with the touch screen device cursor 104 according to some embodiments of the disclosure.

FIG. 5G illustrates another implementation of the directional selection of FIGS. 5A, 5B and 5C according to some embodiments of the disclosure.

FIGS. 6A, 6B and 6C illustrate an implementation of the touch screen device cursor 104 in conjunction with a remote function according to some embodiments of the disclosure.

FIGS. 7A and 7B are network diagrams illustrating example systems for navigating the touch screen device with a touch screen device cursor according to some embodiments of the disclosure.

FIGS. 8A, 8B and 8C illustrate example configurations for implementing the touch screen device cursor according to some embodiments of the disclosure.

FIG. 9 illustrates an example touch screen apparatus for navigating a touch screen device according to some embodiments of the disclosure.

FIG. 10 illustrates a flow chart of a method for navigating a touch screen interface associated with a touch screen device according to some embodiments of the disclosure.

FIG. 11 is a block diagram illustrating an example computer system that may be used in connection with various embodiments described herein. FIG. 8

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

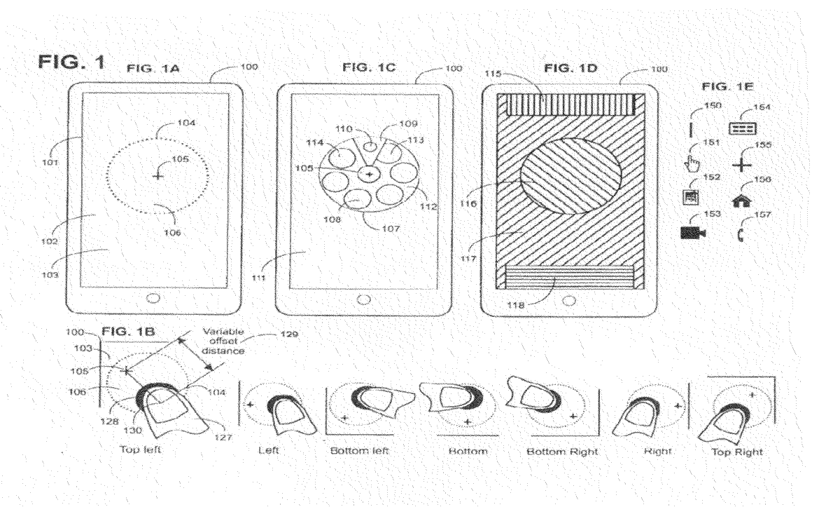

FIG. 1A illustrates a screen shot of an example user interface of a touch screen device 100 according to one embodiment of the disclosure. The touch screen device 100 can be, for example, a cell phone, a personal digital assistant, a multitouch electronic device, a thin client terminal or thin client electronic device client, a TV or electronic device, a tablet or the like. The touch screen device 100 being implemented according to an operating system (not shown), for example, a mobile operating system. The touch screen device 100 includes a multitouch user interface or screen 101, touch screen device cursor 104, a selection or point indicator 105 and a hit area or object contact area 106. The multitouch user interface or screen 101 can be a single touch interface or a multitouch interface such as a thin film transistor liquid crystal display (TFT-LCD) multitouch screen. The touch screen device cursor 104 can be a floating panel that floats on top of an operating system (OS) or application, such as a web browser, a mail application, Windows™ OS, Android™OS, Apple™ OS, Linux™ OS, a file explorer application, or the like. The touch screen device cursor 104 is capable of recognizing different operating systems and application content 103, such as web content that is rendered for example on a web browser or a mail application among others.

The touch screen device cursor 104 may be capable of receiving touch input from an object or object contact 127 at a hit area or object contact area 106, and dragged through the touch screen device 100. The point indicator 105 is associated with the touch screen device cursor 104 and contained in it. Movements by the touch screen device cursor 104 may affect the point indicator 105 such that the touch screen device cursor 104 can be dragged thought the touch screen device 100, in conjunction with the point indicator 105. The touch screen device cursor 104 and the point indicator 105 can move at the same time and at the same speed. While dragged, the point indicator 105 can recognize the content on the screen 101 associated with the operating system or application.

FIG. 1B illustrates a navigation implementations with an object on the touch screen device 100. In some embodiments of the disclosure, the point indicator 105 is activated within the object contact area 106 away from a first contact indicator or object contact touch mark 128. The point indicator 105 can be configured to move within the object contact area 106 in response to the movement of the first contact indicator 128. The first contact indicator 128 can be configured to move in response to movement of the object or object contact 127 when the object 127 is in contact with the touch screen interface 101 (or multitouch user interface or screen) or when the object 127 is sensed by an object sensing controller, for example.

The object contact area 106 and the point indicator 105 can be configured to move in conjunction with the movement of the first contact indicator 128. The first indicator 128 may be configured to move or dragged in response to the movement of the object 127 over the screen 101. The point indicator 105 may be illustrated by a cursor symbol such as an, arrow head, a hand symbol or a cross, for example. The first contact indicator 128 may be illustrated by a marker, such as a black or white touch object mark. The point indicator or selection indicator 105 may be positioned over a target position associated with the touch screen interface in response to movements of the object 127. FIG. 1B further illustrates different positions of the point indicator 105 when the object 127 such as a finger, is moved to different positions on the screen 101.

Finger size affects many different aspects of operating a multitouch user interface or screen 101, from trivial operations such as hitting the target while touching down on a tiny operating system and application content 103, like for example a link rendered on a mobile web browser featured with for example a Webkit (The Webkit Open Source Project http://webkit.org [browsed on Dec. 21, 2007]), to more complex operations like making text selection and manipulating content between applications within the same operating system of the touch screen device 100, like copy and paste. Fingers are inaccurate, they are not sharp and precise, and therefore do not make good pointing tools for a multi-touch surface. For example, compare the size of a finger with the size of a paragraph that is rendered on an operating system and application content 103, for example, a web page rendered on a touch screen device 100. A normal finger would overlap all of the text if placed on over the screen making it difficult to make a selection. It is also difficult to see the text beneath the finger. This problem of finger size also highlights the complication, of selecting text on a touch screen device 100. Another issue that arises due to this inaccuracy is the amount of steps needed to complete simple and complex operations. As there is no precision with our fingers, the steps necessary to do trivial operations are multiplied.

In some embodiments of the disclosure the above described problem are solved by implementing a touch screen device cursor 104 featured with a point indicator 105 that can be relocated according to a variable offset distance 129 between the object contact touch position 130 and the pointer indicator 105. This way, a pointer indicator 105 that is relocated according to a variable offset distance 129 can be dragged on a distant position from the object contact 127 leaving a visible area and preventing an object contact 127 for example a finger, to overlap on top of the operating system Some aspects of the disclosure can be implemented by using types of object contacts 127 like fingers, allowing them to be sharp, precise and efficient.

In some embodiments the pointer indicator 105 can reach all sectors or corners of the a multitouch user interface or screen 101, for example, a TFT/LCD multitouch screen by relocating the point indicator 105 to the opposite side of where the object contact 127 for example a finger contacts the touch screen interface 101. The hit area or object contact area 106 is contacted with the object contact 127 and a controller, for example an object sensing controller, calculates the object contact touch position 130 and location in order to automatically move the pointer indicator 105 to any side of the hit area or object contact area 106. FIG. 1B illustrates how the point indicator 105 can be relocated to different positions. The touch screen device cursor area 116 (FIG. 1D), which may also be the hit area 106 (FIG. 1A) may be implemented in a geometric shape. In some embodiments, the geometric shape is circular. The geometric shape, such as a circular shape, of the touch screen device cursor area 116 may render it a multidirectional tool that can be dragged to any corner of the multitouch user interface or screen 101. In some embodiments, the touch screen device cursor area 116 can be configured to work in conjunction with the pointer indicator 105 so that when the user touches down an object contact 127 like a finger within the hit area or object contact area 106, the point indicator 105 moves to the opposite side allowing a comfortable position to move it in a specific direction.

FIG. 1B shows the different circumstances where the object contact 127 is touched down on different locations of the hit area or object contact area 106 affecting the position of the point 105 and allowing the user to drag the touch screen device cursor 104 to reach substantially all locations on the screen 101. The object contact touch mark 128 graphically indicates the object contact touch position 130 where the object contact 127 hits a multitouch user interface or screen 101. An X and Y squared coordinate, which determines a diagonal line of distance from the finger to the pointer 105, can be calculated by a processing controller (not shown) and kept stored (in memory also not shown) into a variable while dragging occurs. This way all positions can be reached allowing a visible area. FIG. 1B illustrates the point indicator in different positions such as Top left, Bottom, Top Right, Right, Bottom left, Left, and Bottom Right. Then, when a relocation of the point indicator 105 is needed, the user would move the object contact 127 to locate the point indicator 105 to the desired location on the screen 101.

After the point indicator 105 is relocated the object contact 127 can be dragged and moved through the multitouch user interface or screen 101. The point indicator can be configured to recognize the operating system and application content 103 at runtime, and an icon associated with the point indicator 105 can be configured to change according to information associated with the operating system or content application 103. One of the most common applications used on a touch screen device 100 is an Internet browser or navigator. Users are already familiar with gestures for navigating, such as Pan, Zoom, and Navigate. However, these features represent only the tip of the iceberg of what could be enhanced for Internet use. Fingertip size negatively affects the accuracy in navigation that is currently used with the regular personal computer mouse. At the moment, there are too many steps involved in regular navigation while using a web browser on a mobile phone. The user encounters too many pop-ups and confirmation prompts to be able to perform simple actions, like opening a link or copying content from the web and pasting it into an email message. These extra steps ultimately slow down the workflow process. Aspects of the present disclosure reduce these steps and facilitate the selection method to the benefit of the user, allowing faster workflow and more intuitive interaction.

FIG. 1C illustrates a circular menu 107 that can be configured to provide navigation features to the touch screen device cursor 104. The circular menu 107 can be linked to or associated with the touch screen device cursor 104 in such a way that they work in conjunction with each other. The circular menu 107 can be activated by touching down with an object contact 127 along the center of the touch screen device cursor 104. In some embodiments, the circular menu can be activated by touching the point indicator 105. In some embodiments, the circular menu can be implemented on the touch screen device cursor 104 and can be substantially the same size as the touch screen device cursor 104 and can be located in the same spot or position. The circular menu 107 may include a circular menu wheel 112 that can provide circular menu buttons 108 for navigating on the touch screen device 100. The circular menu buttons 108 can be associated with and contained within the circular menu wheel 112.

In some embodiments, a circular menu separator 109 can be located on top of and above the circular menu 107 so that when the circular menu wheel 112 containing the circular menu buttons 108 turns around, the circular menu buttons 108 are displayed. In some embodiments, the circular menu 107 includes a pointing device spin area 111 or remaining area can be configured to receive touch input from an object contact 127 allowing the circular menu wheel 112 to spin. The circular menu pointing device spin area 111 can receive different types of gesture input, for example, fling and lineal drag gestures in both horizontal and vertical ways. When an input gesture such as drag or fling is received, the circular menu wheel spins or turns around and the circular menu buttons 108 are hidden below the circular menu separator 109. A circular menu separator 109 can act like a mask where the circular menu buttons 108 can be hidden and shown below the circular menu wheel 112. While the object contact 127 is moving and the circular menu is spinning, a circular menu incoming button 113 is partially shown on the right side and below the circular menu separator 109. At the same time, a circular menu outgoing button 114 is hidden on the right side and below the circular menu separator 109.

FIG. 1D illustrates exemplary areas of interaction on the touch screen device. The exemplary areas of interaction include a viewer area 115, for example, an event viewing area or viewer 115, a touch screen device cursor area 116, a pointing device selection gesture area 117 and a tutor area, for example a tutor 118. The exemplary areas are associated with each other and configured to work in conjunction by means of coordinated actions, to reduce the amount of steps and number of screens; making the navigation and content manipulation experience as simple as possible. The touch screen device cursor area 116 can be a geometric area, for example, a circle on the screen, and the pointing device selection gesture area 117 can be represented by the remaining squared area. The touch screen device cursor area 116 can be dragged through the screen in order to precisely place the point indicator 105 on top of any type of content 103 while allowing the user to see what is below the desired location on the screen 101. The pointing device selection gesture area 117 can be configured for selection implementatios such as a button or key used for making selections.

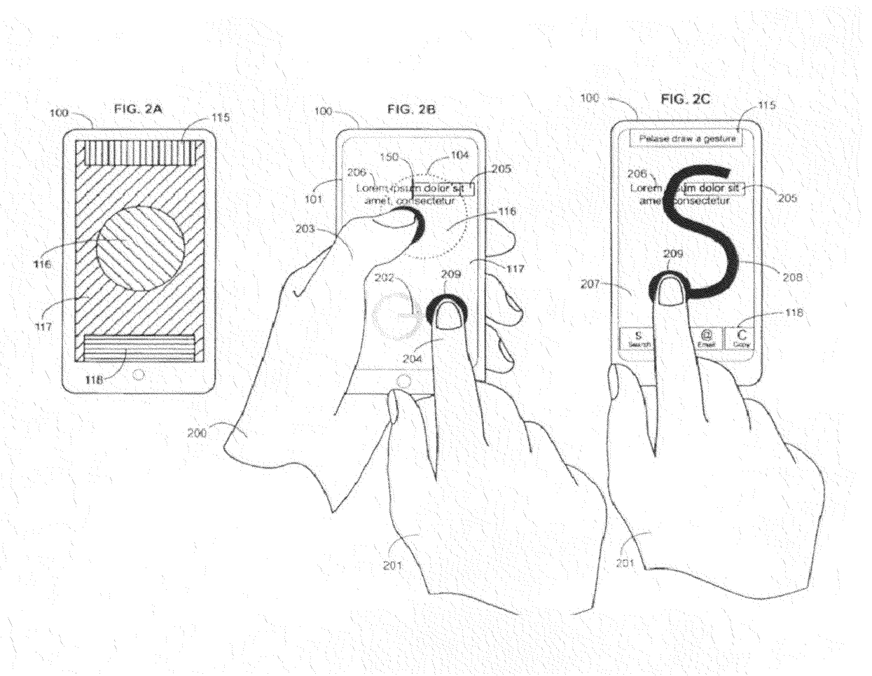

The pointing device selection gesture area 117 can be configured to receive command signals such as gesture inputs or gesture command signals and work in conjunction with the point indicator 105 allowing different types of content selection by means of gestures further described in FIG. 2A. A pointing device selection gestures, for example directional selection gesture, can be implemented in this area. The circular menu 107 can be located inside the hit area or object contact area 106. In the event viewer 115, the user can receive information from the events that are triggered on the remaining areas. For example, there can be an event that says, “gesture completed”, when a gesture is recognized by the application. The event viewer 135 messages can appear when there is a notification. A notification can vary according to the activities. For example, there can be an activity that the user is dragging the touch screen device cursor 104 on top of a content type and the event viewer 115 displays a point indicator over media.

The event viewer 115 can be an optional feature that can be enabled or disabled by a user. The tutor area 118, for example a tutor 118, helps the user navigate the touch screen device 100. In some embodiments, when content is selected, the user can be shown a list of available gestures for performing different actions for the given selection. The tutor 118 can facilitate familiarization of the user with the available gestures to perform actions later referred to as handwriting action gestures 134 or gesture command signals. The tutor 118 can be like an image carousel component that the user can drag to see all the gestures available to perform an action. Once the tutor 118 appears, the user will be able to either draw the handwriting action gesture 134 or touch down on a button of a given gesture for processing.

FIG. 1E shows some of the types of cursors that can be utilized as images for when different content types are identified by the point indicator 105 while it is been dragged. As previously discussed above, the pointer indicator 105 can be relocated according to a variable offset distance 129 between the object contact touch position 130 and the pointer indicator 105 contained within a wider circular area, defined as the hit area or object contact area 106. The object contact area 106 can be dragged and controlled with the object 127, for example a finger, while keeping the point indicator 105 visible to the user. The content below the pointer indicator 105 can be recognized at runtime while the touch screen device cursor 104 is being dragged. As a result of the content recognition below the point indicator 105, in some embodiments, the user can see different cursors with icons that indicate the type of content. This process can be performed at runtime while dragging the object contact area 106.

If there is text, phrase, and paragraph or whatever elements containing text, below the pointer, a text cursor 150 can be displayed. If there is a link associated with a text or media a link cursor 151 can be displayed. If there is an image, an image cursor 152 can be displayed. If there is a video, a thumbnail of a video or a link associated with a video, a video cursor 153 can be displayed. If the point indicator 105 is dragged over an input text, input box or whatever input component that request text from the user where the text can be provided by means of a hardware or software (virtual) keyboard, a keyboard cursor 154 cursor displayed. A virtual keyboard implementation that works in conjunction with the touch screen device cursor is discussed further in Patent Publication No. 20090100129, which is hereby incorporated by reference in its entirety. If below the point indicator 105 there is no content, this, for example a blank space with no content information, a no target cursor 155 can be displayed. If below the point indicator 105 there is a map or a map link associated with a map indicating an address, a map cursor 156 can be displayed. If there is a phone number either within a given paragraph, phrase, text or whatever sequence of numbers that are recognized as a phone number, a telephone cursor 157 can be displayed to the user. The difference between selecting with one cursor or another is that a different set of handwriting action gestures 134 can be enabled accordingly and shown on the tutor area 118. These icons may be similar to the current icons used while navigating a real web page on a regular personal computer PC by means of a mouse pointer. Advanced cursors can include input voice cursor, where the user can speak to a given input by means of the voice. This cursor as well can be included into the set of cursors.

FIGS. 2A, 2B and 2C illustrate demonstrations of some functions of the touch screen device cursor. FIG. 2A is similar to FIG. 1D explained above. In some aspects of the disclosure, a touch screen device 100 is operated with both hands, left hand 200 and right hand 201, to improve control of the touch screen device cursor 104 allowing a fast and accurate interaction with the operating system and application content 103, for example. The user can select text by means of gestures. The screen device cursor 104 can be dragged with the first touch dragging device object 203 to a desired text content 206 as shown in the FIG. 2B. While the touch screen device cursor 104 is dragged the point indicator 150 can recognize the different types of content below and change the cursor as shown in FIG. 1E above. Given that in this case the content or target information is text 206, the point indicator 150 switches to a text cursor 150 indicating the user the presence of text below. Once in this position, the pointing device selection gesture area 117 is enabled for the user to perform a pointing device selection gesture 202. The pointing device selection gesture 202 is associated with the text cursor 150. The section of the text 206 can be highlighted (highlighted text 205) according to the dragging movement of the second touch selection object 204. An X,Y coordinate below the text cursor indicates the starting position of the highlight or selection 205. Once the pointing device selection gesture 202 is received and the second touch selection object 204 dragged to the right, a highlighted text in light blue, for example, or selection 205 is started in the same direction as the performed gesture and continues until the second touch selection object 204 is lifted. This way the pointing device selection gesture 202 controls the highlighted text 205 according to the user's needs. Once the selection is finished and the user is satisfied the second finger is lifted and the a communication gesture layer 207 is enabled as in FIG. 2C. FIG. 2C illustrates the process in which the selected text is executed in a command by means of a handwriting action gesture 208. In the FIG. 2C, the selected text or highlighted text in light blue 205 can be copied to the clipboard, for example, the tutor area 118, shown to the user with the available gestures for the text cursor 150 and the viewer area 115. The amount of handwriting action gestures 208 available for an operation can depend on the type of cursor. Each cursor can have a different set of gestures that perform different actions that are stored into a portable gesture library that can be customized by the user according to his/her needs. Pointing device selection gestures 202 can also be stored into the portable gesture library. In FIG. 2C, the user performs an “S” handwriting action gesture 208 in order to make a search of the selected text content 206 into a search engine for example Google™ search engine and the result is the rendered or shown on the a multi-touch user interface or screen 101.

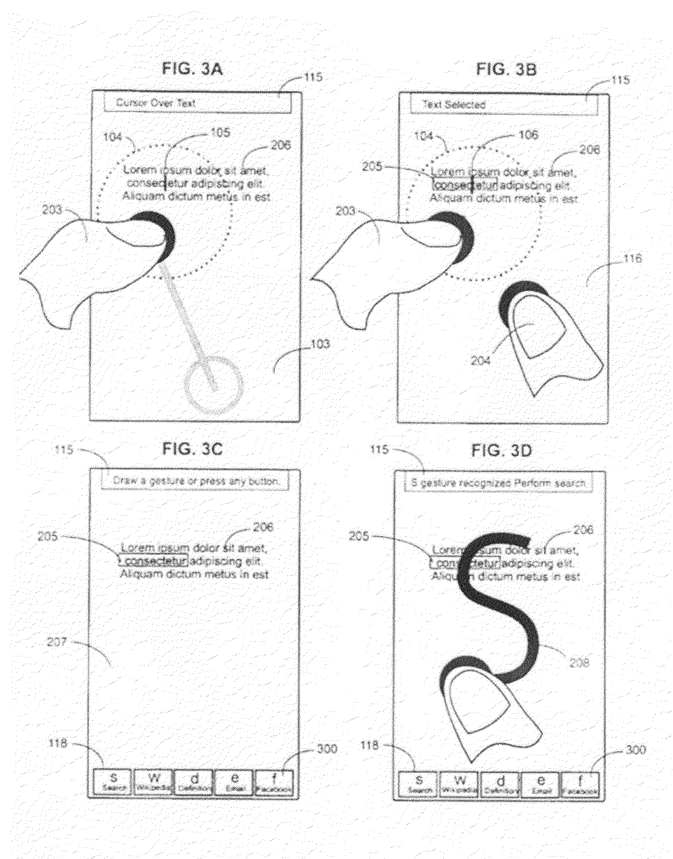

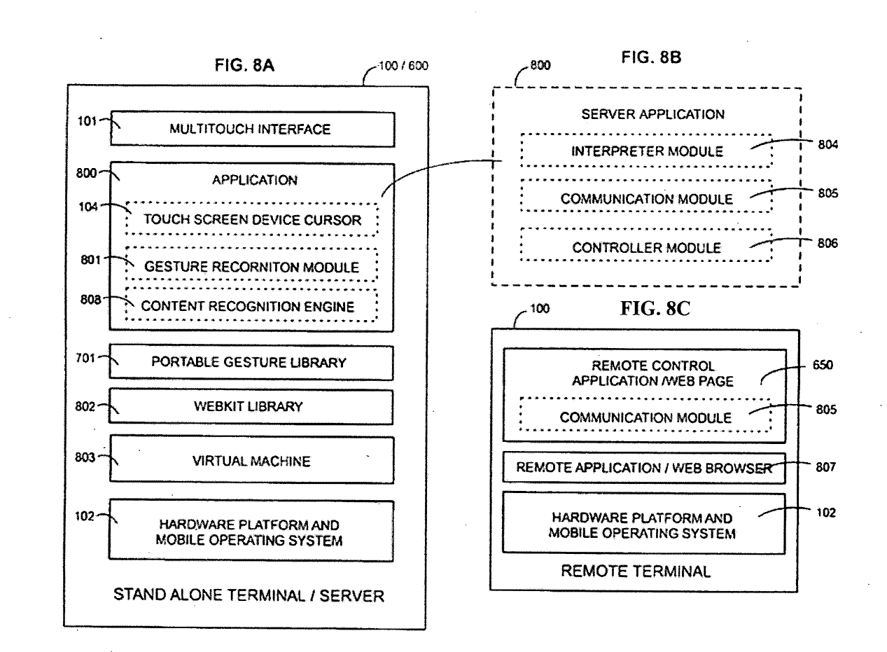

FIGS. 3A, 3B, 3C and 3D illustrate a touch screen device cursor navigation workflow in a sequence according to some embodiments of the disclosure. The illustrations demonstrate how a user can search a word on a search engine, for example Google™ Search Engine. In particular, FIGS. 3A, 3B, 3C and 3D illustrate a workflow of an application, for example, application 800 described with respect to FIG. 8. In FIG. 3A, the user drags the touch screen device cursor 104 with the first touch dragging device object 203. While the point indicator 105 moves above or operates over the operating system and/or application content 103, a content recognition engine, for example content recognition engine 808 described with respect to FIG. 8, queries for different types of contents below the point indicator 105 at runtime. Additionally, in the event viewer 115 the user can indicate the type of cursor displayed with a legend such as “Cursor Over Text.” If a different type of content is found, the point indicator 105 can be changed according to the associated cursor (see FIG. 1E for types of cursors involved).

If there is any link 400 below the point indicator 105 (made of text or image example), a link ring mark 401 (shape around the boundaries of the link that determine the area to be selected) can mark the link size so the user can recognize it as link 400. Once the point indicator 105 is on top of the desired text content 206, the touch screen device cursor area 116 can be enabled so the user can then touch down or make contact with a second touch selection object 204 in order to select the word right below the text cursor 150 as in FIG. 3B. When the user touches down the second touch selection object 204, the word 205 that is below the text cursor 150 can be highlighted and additionally the event viewer 115 can show a legend “Text Selected.”

In order to perform the handwriting action gesture 208 it may be optional that the user have the first touch dragging device object 203 down or touching the screen 101. In some embodiments, once the word is highlighted, the touch screen device cursor 104 disappears (optional). In FIG. 3C, the tutor area 118 is shown with tutor area buttons 300. The tutor can be a set of buttons 300 that can be associated with one or more handwriting action gesture 208 for the user to select. The event viewer 115 may display the legend “Draw a gesture or press any button” informing the user of the options to perform a handwriting action gesture 208. Finally, FIG. 3D, the user performs a handwriting action gesture 208 on one of the communication gesture layer 207. In this case, the handwriting action gesture 208 is an “S” to search the work on an online search engine like, for example Google™ Search Engine. A web page can then be displayed to the user showing the result of the searched word.

In some embodiments, the handwriting action gestures 208 can be configured to be processed and sent to any third party online application programming interface (API) (for example, Facebook™, Twitter™, etc.), a third party application (i.e. mail), to the operating system or even download and store the selected data or information. For example, if the user selects within their text a term or place that they would later like to search, he or she can first select the word(s). Then the user can draw an S for “search” on the screen. This action may be interpreted or may indicate in the application that the selected content is to be placed in a search engine webpage. On the same screen, the user can be presented with the results of the search on their selected text. Using gestures as commands means fewer steps in the process.

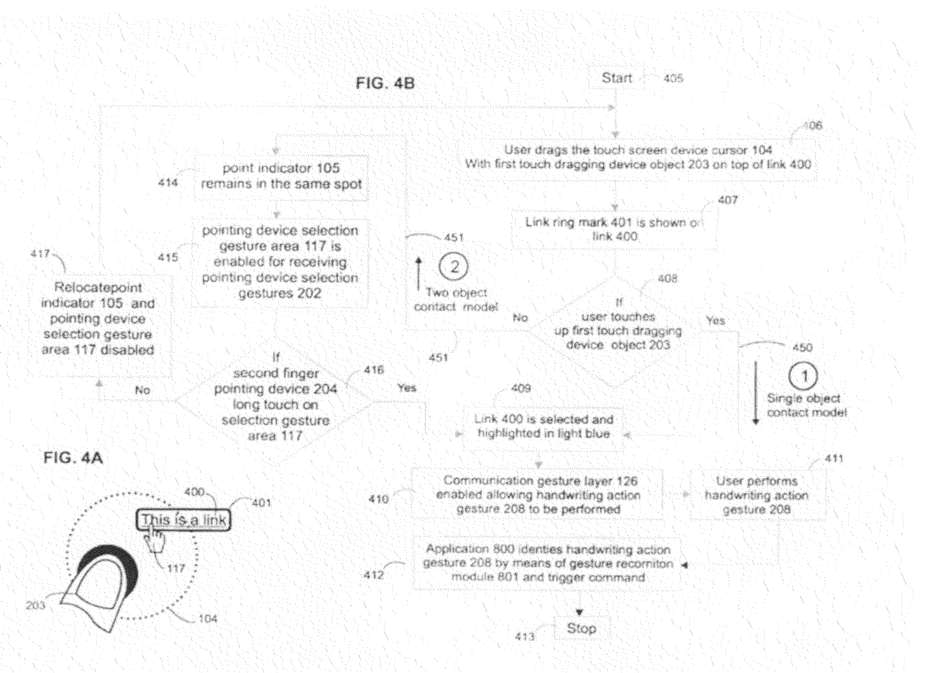

FIG. 4A touch screen operation on the touch screen device 100 with the touch screen device cursor 104. The touch screen device cursor 104 while being dragged by a first touch dragging device object 203 on top of a target information, for example, link 400 labeled “This is a link”. FIG. 4A demonstrates switching of the point indicator 105 to a link cursor 151 at the same time that a link ring mark 401 is drawn around the link 400 indicating to the user that the link 400 is available for selection.

FIG. 4B illustrates a flowchart indicating two types of interactions, a single object (finger) 127 interaction case “1” and two objects (fingers) interaction case “2”. In both cases, the user can select a link 400 and execute a handwriting action gesture or gesture command signal 208 to perform an action such as sending the link by email. The single object contact model 450 indicated in the FIG. 4B includes object contact 127 or 203 and the two object contact model 451 indicated in the FIG. 4B includes two object contacts. In both cases, a user interacts with the touch screen device 100, for example, a cellPhone/tablet or a thin client electronic device, using object(s) 127 such as the user's fingers. At block 405, the user turns on the cellPhone/tablet 100 and opens the operating system and application content 103, for example a web browser. At block 406, the user drags the touch screen device cursor 104 with first touch dragging device object or object contact 203 on top of link 401. At block 407, the link ring mark 401 is shown on link 400 at the same time that the point indicator 105 changes to a link cursor 151 (e.g., small hand). At block 408 if the user touches up or lifts the first touch dragging device object 203 and the application 800 is operating on single object contact model 450, i.e., case “1”, the link 400 is selected and highlighted in light blue, for example, as shown at block 409. Then as illustrated at block 410, a communication gesture layer 207 can be enabled to allow handwriting action gesture or gesture command signal 208 to be performed. The communication gesture layer 207, may be associated with a gesture controller or a server that performs or allows the gesture function to be performed remotely or at the touch screen device 100.

At block 411, the user performs handwriting action gesture or gesture command signal 208, for example an “@” handwriting gesture 208 to send the link 400 via mail, for example. At block 412 the implementation stops. While the implementation stops for explanatory purposes, of case 1, the action actually continues by processing the gesture command signal 208. For example, an application 800 (explained later with respect to FIG. 8) identifies the handwriting action gesture 208 “@” by means of gesture recognition module 801 (explained later with respect to FIG. 8) and trigger a response by, for example, opening the mail application and pasting the selected link 400 on the mail body. In case “2”, at block 408. If the user does not touch up or lift the object contact 203 from the screen 101 the object contact 203 remains down. As a result, at block 414, the point indicator 105 remains in the same spot. This action enables the pointing device selection gesture area 117 for receiving pointing device selection gestures 202. At that point the user can choose to keep on dragging the touch screen device cursor 104, to relocate the point indicator 105 or to perform a pointing device selection gesture 202 with a second object contact 204 (e.g., second finger) to select the link 400. At block 413, if the second finger pointing device or second object contact 204 is touched down or is making or makes contact with the screen 101 for a predetermined period of time on the touch the selection gesture area 117, the link 400 is selected and highlighted in light blue, for example. The user may then follow the same path of blocks 410, 411 and 412 as described just above to ultimately paste the link 400 on a mail body. If in block 416, the user decides to touch up or lift the first touch dragging device object 203, the point indicator 105 may be relocated to the center of the touch screen device cursor 104 and the pointing device selection gesture area 117 can be disabled. After that, the flowchart can start again at block 405.

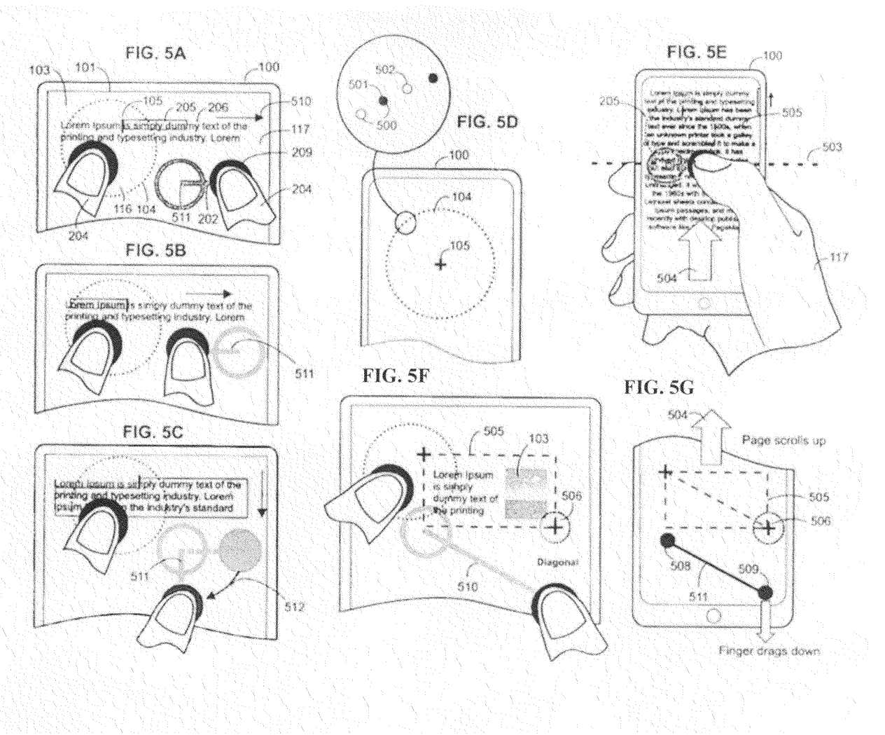

FIGS. 5A, 5B and 5C illustrate touch screen device cursor navigation implementing a directional selection method. For explanatory purposes, FIGS. 5A, 5B and 5C will be discussed in reference to FIG. 2B. In some embodiments, when text cursor 150 is located on top of a desired text content 206 or paragraph, the user can touch down or make contact with the screen 101 with the second touch selection object 204 and drag to a desired direction or location. Once the second touch selection object 204 is moved, the highlighted text 205 can be established on an XY coordinate location where the text cursor 150 is located and towards the direction of the dragging movement of the second touch selection object 204. A dragging line 511 can be drawn on the multi-touch user interface or screen 101 from the touch point origin X, Y to the dragging point providing a user with a track of the movement performed. The dragging movement in conjunction with the selection highlighted text 205 and the dragging line 511 provides the user total control of the ongoing selection on the screen 101. This implementation may be referred to as a directional selection method because after the dragging movement is started the user can switch the direction.

If the user switches the direction back and drags the second touch selection object 204 back in the opposite direction as in FIG. 5B, the highlighted text 205 selection can move backwards, pass from starting point X, Y and approach the opposite direction. If the user drags the finger down as in FIG. 5C, the highlighted text 205 selection can be moved down or up accordingly. The user can start a selection and then make a circular dragging movement 512 affecting the direction of the selection. The selection parameters (for example, speed of selection) of the highlighted text 205 can also be controlled by a long or a short drag. The longer the drag the faster the highlighted text 205 is selected. This way there is a control of the speed of the ongoing selection. The selection parameters related to making selections while dragging can be controlled in different ways. For example, limits or tops can be set to the ongoing highlighted text 205 animations that can allow the user to stop the selection or animation at a precise limit. These tops of limits can be set to the parameters of the text or information to be selected, for example word count, or on the technical aspects of the markup language, for example HTML markup language.

Once the directional selection reaches the limit (text or information parameter or technical) the selection of the highlighted text 205 is stopped. The directional selection feature limitations can be configured such that upon reaching a limit the selection is stopped for a predetermined period and then continue with the selection. The continuation of the selection can be continued after an affirmative action instead of the predetermined time feature. The limits can be technical delimiters or grammatical, text or information delimiters. Technical's: There should be different levels of breaks or pauses. For example, a </DIV> or a </P> would mean a 1 second pause, while an </A>, </B>, or <SPABN> should represent a ½ second pause. This should of course be tested in order to measure the proper pause time. Grammatical: This has the similar criteria as the technical. there are hard pauses (i.e. a period or a quote) and there are soft pauses (i.e. a coma, a “-”, or a single quote). In this scenario, the longer you drag the shorter the pause periods should be. On the other hand, the quicker you drag the longer the pauses. This of course should have a name and could be enabled in settings. This is also something that can be written in the patent.

FIG. 5D illustrates an exemplary implementation of the touch screen device cursor 104. The geometrical shape, for example curricular shape, makes touch screen device cursor 104 multi-directional and easy to drag. In some embodiments, the screen device cursor 104 may be composed of a series of dots 500, which enhance the concept of multi-directional tool. The color of the touch screen device cursor 104 can be selected to enhance the color of the operating system and application content 103, like for example a web browser upon which the touch screen device cursor 104 runs. For example, because web pages can vary in terms of their color the touch screen device cursor 104 was featured with black dots 501 and white dots 502 alternatively distributed along the touch screen device cursor 104. Therefore, if the content below is darker, the white dots 502 are seen while, if it is lighter, the black dots are seen. This way all content colors of the palette are supported without disturbing the interaction.

FIG. 5E illustrates an implementation of the directional selection of FIGS. 5A, 5B and 5C. In particular, FIG. 5E contemplates when the ongoing highlighted text 205 selection reaches the second touch selection object 204 at line 503. When the ongoing highlighted text 205 selection reaches the second touch selection object 204 at line 503, the operating system and application content 103, can be scrolled up as indicated by up arrow 504. This same method can also be applied while selecting from bottom to top. This way the user is can be in control of what is been selected.

FIG. 5F illustrates an implementation for selecting big chunks of operating system and/or application content 103 with the touch screen device cursor 104. A big chunck of data may be, for example, a chunk of web page rendered by a web browser. The implementation of FIG. 5E will be discussed with respect to the implementations of FIGS. 5A-5C already explained above. The no target cursor 155 was designed to indicate the user when there is nothing below the touch screen device cursor 104. This means that when there is no text, image, video or other information recognized, the no target cursor 155 is shown. While the no target cursor 155 is active, the user can still perform a diagonal dragging movement on the pointing device selection gesture area 117 from the first touch point 508 until the end touch point 509 determining a selection highlighted square 505 defined by the hypotenuse 511 of the diagonal. This way, while using touch screen device 100 like for example a tablet, the user could drag the touch screen device cursor 104 on the upper part of the a multi-touch user interface or screen 101 with the first touch dragging device object 203 while making diagonal selection gestures with the second touch selection object 204. As a result the selection highlighted square 505 may copy the operating system and application content 103 below to the clipboard, the communication gesture layer 207 can be enabled to perform associated handwriting action gestures 208 to the no target cursor 155. Similar to the illustration of FIG. 5E, when the end touch point 509 reaches the bottom of the touch screen device 100, the operating system and application content 103, can scroll up as indicated in up arrow 504 (see FIG. 5G). The scrolling up may occur as long as the active end touch point 509 and the second touch selection object 204 are not lifted up.

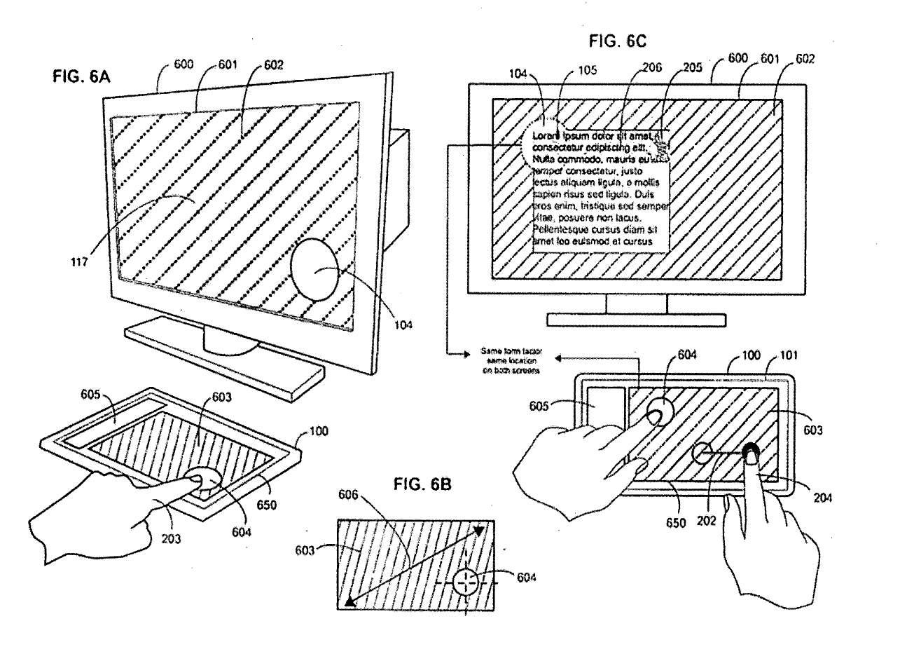

FIG. 6 illustrates an implementation of the touch screen device cursor 104 in conjunction with a remote function. Although aspects of the disclosure are presented as a solution to be implemented on top of a multi-touch user interface or screen 101, for example, a TFT/LCD multi-touch screen, devices in order to manipulate content by means of gestures, some aspects may be implemented in conjunction with or on other systems. In FIG. 6A, a non-traditional television (TV) 600, for example GoogleTV™ running a server, illustrates a touch screen device cursor area 116 and pointing device selection gesture area 117 as similar to those described with respect to FIG. 1D. Non-traditional TV 600 or other systems utilizing touch screen devices are featured with a multi-touch user interface or screen 101 that could allow the user to interact directly with the areas on the non-traditional TV 600 or other touch screen systems. In some embodiments, the other touch screen device systems 600, such as the non-traditional TV can be controlled remotely from a remote touch screen device cursor area 604 and a remote pointing device selection gesture area 603 running on a remote touch screen device 100. As previously illustrated above, examples of such touch screen devices 100 include a cell-Phone/tablet or a thin client electronic device. In some embodiments, a substantially similar layout is created for the interface layout and scenario on the non-traditional TV 600 acting as server that is on a touch screen device 100. Both with the same form factor and same layout acting in conjunction where the remote areas on the touch screen device 100 work in conjunction with the areas of the non-traditional TV 600, so each movement or gesture on the remote thin terminal 100 affects the one running on the non-traditional TV 600 accordingly. So when the user touches the remote touch screen device cursor area 604 with the first touch dragging device object 203 and drags it on the remote touch screen device 100, the touch screen device cursor 104 on the non-traditional TV 600 is moved. This way the user that already knows how to use the aspects of the disclosure locally (directly on the a multi-touch user interface or screen 101 as previously described on FIG. 2)

The server is implemented in such a way that once is started, it is ready to receive connections from the terminals. For the user to be able to connect to the server, the thin terminal account should be internally linked to the server account. It is not possible to connect to any server unless you have a validated account. This is a security measure in order to prevent inappropriate use. Once validated and the protocol is opened, the first thing that the Touch Screen Device Pointer server does is inform the thin terminal of the form factor it is using, as well as the size of the Touch Screen Device Pointer Area and Selection Area (there are standard measures, however any thin terminal can connect to any server with different form factors), so that once the thin terminal knows the form factor, it renders the circular canvas (remote Touch Screen Device Pointer) and the square canvas below (remote selection area).

Like mirror views with the except that on the TV, the real Internet and application output is shown, and on the remote thin terminal only the elements of remote control that have the same form factor but the sole purpose is to control the remote pair of areas. On the server, the real Touch Screen Device Pointer that can be dragged through the screen and on the thin terminal a solid circle made of forward that can be dragged through the screen of the thin terminal. (this sentence does not make sense). Every time this happens, the Touch Screen Device Pointer on the server is moved in the same way, like a mirror. This is possible by the opened communication that exists between the thin terminal and the server. Collaborative interaction: The system also supports collaborative interaction in different cases. Case 1: Two thin terminals collaborating to control a same Touch Screen Device Pointer. Case 2: Two thin terminals with one Touch Screen Device Pointer each control two different Touch Screen Device Pointers on the server, which share the same screen. In Case 1, a user could be using two thin terminals at the same time, where in one he drags the Touch Screen Device Pointer, and in the other, he performs the Pointing Device Selection Gestures and Handwriting Action Gestures. In Case 2, two users with one thin terminal each could be operating two different Touch Screen Device Pointers on the same web page, for example, making different selections of different content on the page, and then triggering background processes to provide the results simultaneously. The possibilities of interaction are endless. Split screen, different Touch Screen Device Pointer on each split: If there is a change of the TV form factor (i.e. screen split on the FT server), the thin terminal should be informed at runtime and should adjust to the ongoing layout. In the case of split screen, on each new screen that is created a new Touch Screen Device Pointer should be generated. Then, a third device or second thin terminal could connect to the Touch Screen Device Pointer Server in order to use the second Touch Screen Device Pointer. This does not mean that within one side of the split there can be the possibility of having at least two Touch Screen Device Pointers. The already developed Pointing Device Selection Gestures and commands gestures (such as tracing an “S” to instantly post selected content to Google Search, or tracing a “W” to bring up content on Wikipedia) can be stored in a remote server as binary information and then downloaded to a device that would be able to recognize it. All the gestures familiar to the user, used to operate the Touch Screen Device Pointer on the same tablet where the touch interface is located, can also be downloaded to a second device for the user to trigger remotely (e.g. where the GoogleTV™ screen is) by means of the simple server petition or synchronization method.

The benefit of using the same set of gestures on a remote device that were used with a tablet or cell phone is that the user is already familiar with them. In terms of functionality, when the present invention is operated remotely, there is a separation of the functionalities into two: the features that run on the TV application (server side) and the features that run on the tablet (client side) where the remote pad and keyboards reside. On the TV side, the Touch Screen Device Pointer can remain intact in terms of look and feel; it can move just as if it were controlled on the same TV. However, with the remote tablet is where things change. First, the main difference is the gestures; the whole set of available and customizable gestures on the TV, can travel through the network to the client tablet and are available to be used in a remote pad. Since the remote pad has the same form factor as the TV screen, the user can drag a circle with the same size as the Touch Screen Device Pointer by simply touching down on it and moving it in the desired direction. A hit area of the circle located on the pad should be able to receive input from the user with one finger, while the rest of the pad square (what is left of the square) can remain for the user to make selections, macro gestures, and zoom and pan gestures; this way, when the user drags the circle on the remote tablet pad, the Touch Screen Device Pointer on the TV is moved in the same way on the TV. This means that the same concept that was used while operating the present invention below the tablet interface now responds with a remote pad and a circle. Dragging the circle can move the remote Touch Screen Device Pointer, and making a tap with a second finger on the area that is not the hit area of the small circle can ultimately select a word on the TV browser. This same principal also applies to the circular menu and macro gestures.

The Touch screen device cursor server is a special custom build of the present invention, designed to be remotely controlled from third terminals. As a general concept, the operation that the user performs on the thin terminal affects the Touch screen device cursor server at runtime as if it were a mirror. On the Touch screen device cursor server, there are a series of custom modules. A communication module sends and receives data between the terminals and the Touch screen device cursor server. An interpreter module is in charge of reading and understanding the message brought from the terminals and instructs a controller module to execute the action. The Touch screen device cursor server can communicate with the thin terminal by means of computer communication protocols, such as 802.11 Wireless Networking Protocol Standards, by means of IPX/SPX, X.25, AX.25, AppleTalk, and TCP/IP. The way to establish the communication can be by different means, socket connection, HTTP, SSH, etc.; however, more appropriate protocols can be implemented, like the one created by the Digital Living Network Alliance (DLNA). Although DLNA uses standards-based technology to make it easier for consumers to use, share, and enjoy their digital photos, music and videos, it is not limited to that use but is also opened for terminal and server to communicate in our present invention. The custom protocol to which terminals and Touch screen device cursor server can speak should be based on the most effective way of communicating and interpreting the elements involved in the custom communication. In order to reproduce the gestures that the user is performing on the thin terminal (which can then be executed on the server at runtime), the protocol has been created in order to incorporate the following elements: Pointing Device Selection Gestures and Handwriting Action Gesture Gestures (not only identifying the type of gesture performed i.e. “S”, but also tracking the movements of the fingers in the case of the zooming and doing Directional Selection), Pointer Coordinates sent as (X, Y) numbers according to the position of the remote Touch screen device cursor server Area, the Diameter of the Touch Screen Device Pointer, Roaming Keyboards Key strokes, and Parking Mode status, etc. The protocol can be transferred as a series of custom commands that can be read by the Interpreter module (see “Interpreter Module” below) and sent to the controller module accordingly.

An interpreter module on the server side analyzes the incoming message from the thin terminal directly instructing the Web View (with custom methods) to perform the instruction that came through the network. Ultimately, the Touch screen device cursor server is affected on the Touch screen device cursor server, in the same way that it was altered on the thin terminal. However, the communication is not only limited to what is being transmitted between the Touch screen device cursor server and the thin terminal but also to what happens with the information at the external cloud server. Therefore, there is not only communication between server and thin terminal, but also between them and the cloud server. Have in mind that all the user configurations and settings are stored on the cloud server. Having said this, both the Touch screen device cursor server and thin terminal should download the same settings data from the server, gestures and settings are downloaded from the cloud in the same way. For example, the XML that is downloaded to determine the Circular Menu buttons should be read by both applications in order to render the same amount of buttons and performing the same action so that when the CM is opened it can be opened on the Touch screen device cursor server or the thin terminal. For more information on how the CM is created and customized please check 17.1 Circular Menu customization and storage, since it is the same exact procedure that the local version of the invention has, but duplicated on both the touch screen device cursor server and the thin terminal.

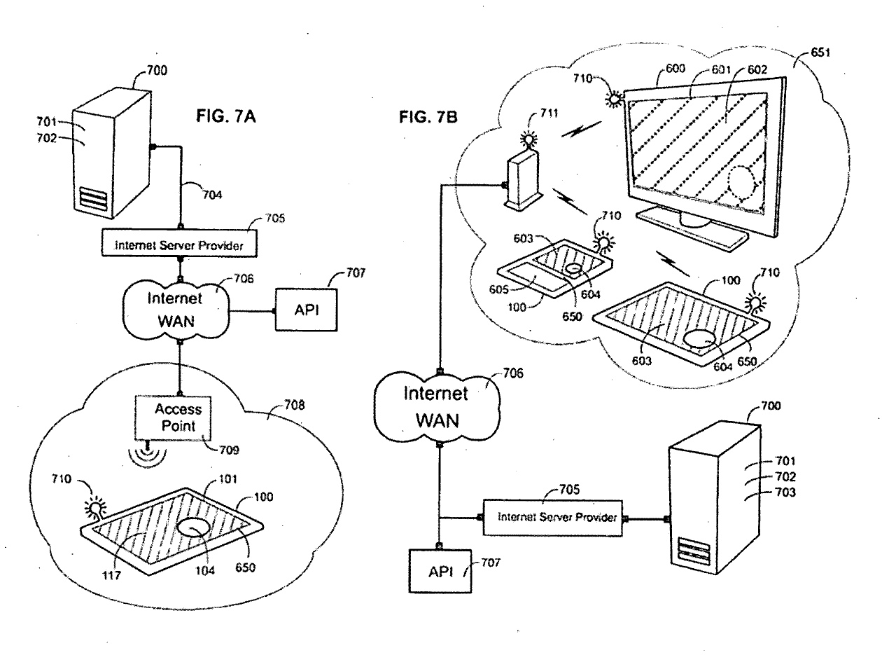

FIGS. 7A and 7B are network diagrams illustrating example systems for navigating the touch screen device with a touch screen device cursor. FIG. 7A explains how the touch screen device 100 is utilized on the same multi-touch user interface or screen 101 locally as in FIG. 2B. The touch screen device 100 works in conjunction with the cloud server 700. The cloud server 700 stores data that is synchronized to the touch screen device 100 including: a portable gesture library 701, containing customized gestures including handwriting action gestures 203 and pointing device selection gestures 202 and application settings 702. An Internet Server Provider 705 connects the cloud server 700 to the Internet 706. The touch screen device 100 connects to external API for example Facebook™ and Twitter™ 707 thought an access point 709 by means of a wifi interface 710. In FIG. 7B there is a similar network configuration however there are some differences. It is featured to run the aspects of the disclosure remotely as described in FIG. 6. In this case, a home network 651 is featured with a non-traditional TV 600 controlled by two remote touch screen devices 100. A cloud server 700 stores a portable gesture library 701 that is downloaded both to the non-traditional TV 600 and both touch screen devices 100 and also keyboard files with interface layout data 703 in conjunction with a user account configuration and settings. The layout of the remote interface 650 can be generated at runtime including remote pointing device selection gesture areas 604, remote touch screen device cursor area 603 and roaming keyboards area 605.

FIGS. 8A, 8B and 8C illustrate example configurations for implementing the touch screen device cursor. In FIG. 8A, a stand alone terminal 100 (e.g., touch screen device) or server 600 is featured with a multi-touch interface 101, an application 800 or custom program contains a touch screen device cursor 104, a gesture recognition module 801 and a content recognition engine 808. The portable gesture library 701 is downloaded from the cloud server. A webkit library 802, a virtual machine 803 and a mobile operating system 102. FIG. 8B, illustrates the custom modules located on the server application 800 that run on the non-traditional TV 600 of the server which are: A communication module 805, an interpreter module 804 and a controller module 608. These three are in charge of coordinating the action between the remote terminals 100 and the server application 800. The reaming parts of software of the server application 800 are the same as in FIG. 8A. FIG. 8C illustrates the software configuration of the remote terminals 100 featured with a thin client compound of a remote control application/web page 650 (custom application) featured with a communication module 805 to connect to the module on the server 805. A remote application/web browser 807 and a mobile operating system 102.

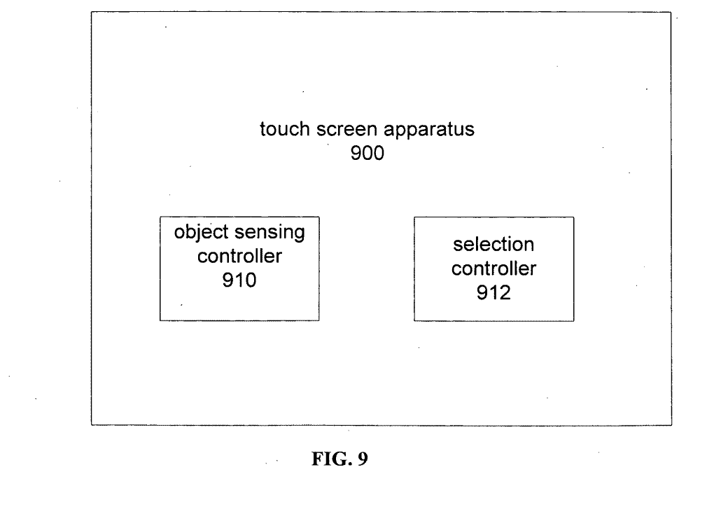

FIG. 9 illustrates an example touch screen apparatus 900 for navigating a touch screen device. The apparatus may include an object-sensing controller 910 configured to activate the first contact indicator or object contact touch mark 128 within the object contact area 106 on the touch screen interface 101 of the touch screen device 100. The touch screen apparatus 900 also includes a selection controller 912 configured to activate the point indicator 105 within the object contact area 106 away from the first contact indicator 128. In some embodiments, the apparatus 900 may be implemented within the touch screen device 100. In some embodiments, the apparatus 900 may be implemented external to the touch screen device. In some embodiments, sections of the apparatus, for example, the objective sensing controller 910 or the selection controller 912 may be implemented within the apparatus 900, while other sections are implemented outside of the apparatus 900.

The object contact area 106 can be configured to move within the touch screen interface in response to a movement of the first contact indicator 128. The point indicator 105 can be configured to move within the object contact area 106 in response to the movement of the first contact indicator 128. The point indicator indicator 105 can be configured to be positioned over a target position associated with the touch screen interface to facilitate selection of target information for processing.

In some embodiments, the object sensing controller 910 and the selection controller 912 can be remotely located, in a remote server for example, or located locally on the touch screen device 100. In some embodiments, the object-sensing controller 910 can be configured to activate the first contact indicator 128 in response to an object 127 contacting the touch screen interface 101 or sensing the object within a vicinity of the touch screen interface 101. The selection controller 912 can be configured to activate the point indicator 105 in response to the activation of the first contact indicator 128. In some embodiments, the apparatus may include a processing controller (not shown). The processing controller can be configured to process the target information 205 in response to a gesture command signal 208 on the touch screen interface 101 with the object 127.

The processing controller, the object sensing controller 910 and the selection controller 912, may be implemented or integrated in the same device. In some embodiments, the processing controller, the object sensing controller 910 and the selection controller 912 may be implemented remotely, at a remote server, for example server 700, or locally at the touch screen device 100. The object sensing controller 910 can be configured to activate a second contact indicator 209 away from the first contact indicator 128. The second contact indicator 209 can be configured to be moved around to select the target information 205 in reference to the target position indicated by the touch indicator 105. The second contact indicator 209 can be activated outside the object contact area 106. In some embodiments, the object-sensing controller 910 can be configured to activate a geometrically shaped menu 107. The geometrically shaped menu 107 can be configured to provide navigation features to the touch screen device.

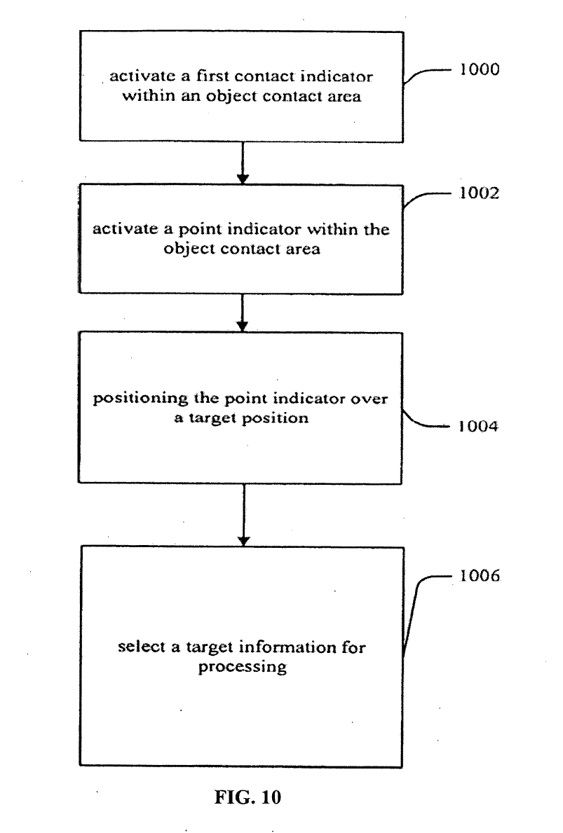

FIG. 10 illustrates a flow chart of a method for navigating a touch screen interface associated with a touch screen device. The method can be implemented in the touch screen device 100 of FIG. 1. In block 1000, a first contact indicator within an object contact area on a touch screen interface of the touch screen device is activated. In block 1002, a point indicator within the object contact area away from the first contact indicator is activated. In block 1004, the point indicator is positioned over a target position associated with the touch screen interface. In block 1006, a target information is selected for processing.

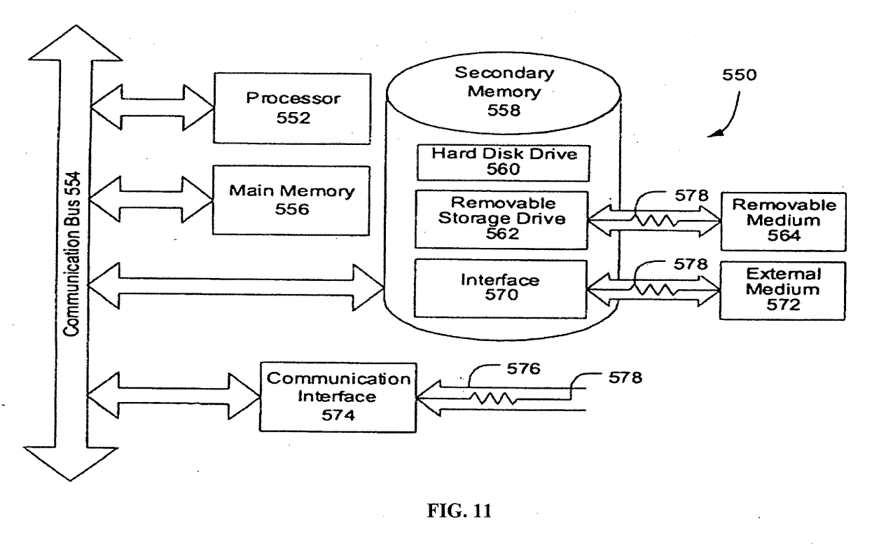

FIG. 11 is a block diagram illustrating an example computer system 550 that may be used in connection with various embodiments described herein. For example, the computer system 550 may be used in conjunction with the touch screen device 100 previously described with respect to FIG. 1. Other computer systems and/or architectures may also be used as can be understood by those skilled in the art. In some embodiments, the computer system 550 may also be implemented as a remote server described herein.

The computer system 550 preferably includes one or more processors, such as processor 552. In some embodiments the object sensing controller, the selection controller and the processing controller can be implemented on a processor similar to processor 552 either individually or in combination. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor. 552, preferably causes the processor 552 to perform the inventive features and functions previously described herein.

Various embodiments may also be implemented primarily in hardware using, for example, components such as application specific integrated circuits (“ASICs”), or field programmable gate arrays (“Fogs”). Implementation of a hardware state machine capable of performing the functions described herein can also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter, which is broadly contemplated by the present invention. It is further understood that the scope of the present invention fully encompasses other embodiments that may become obvious to those skilled in the art and that the scope of the present invention is accordingly not limited.

What is claimed is:

1. A method for navigating a touch screen interface associated with a touch screen device comprising:
activating a first contact indicator within an object contact area on a touch screen interface of the touch screen device, the object contact area configured to move within the touch screen interface in response to movement of the first contact indicator;
activating a point indicator within the object contact area away from the first contact indicator, the point indicator configured to move within the object contact area in response to the movement of the first contact indicator;
positioning the point indicator over a target position associated with the touch screen interface; and
selecting a target information for processing, in whichthe target information is selected in reference to the target position.

2. The method of claim 1, in which activating the first contact indicator further comprises activating the first contact indicator in response to contacting the touch screen interface with an object.

3. The method of claim 1, in which activating the point indicator further comprises activating the point indicator in response to the activation of the first contact position indicator.

4. The method of claim 2, in which processing the target information further comprises generating a gesture command signal on the touch screen interface with the object to activate processing of the target information.

5. The method of claim 4, in which, in response to generating the gesture command signal, generating a command response associated with the command signal generated.

6. The method of claim 5, in which generating a command response further comprises processing the gesture command signal at a processor device and providing a result according to the command signal.

7. The method of claim 1, in which selecting the target information further comprises, activating a second contact indicator, and moving the second contact indicator to select the target information in reference to the target position.

8. The method of claim 7, in which the target information is selected by one of moving the second contact indicator angularly away and moving the second contact indicator angularly toward the target position to select the target information in reference to the target position.

9. The method of claim 1, further comprising generating a geometrically shaped menu within the object contact area, in which the geometrically shaped menu is configured to provide navigation features to the touch screen device cursor.

10. A system for navigating a touch screen interface associated with touch screen device comprising:
an object-sensing controller configured to activate a first contact indicator within an object contact area on a touch screen interface of the touch screen device, the object contact area configured to move within the touch screen interface in response to movement of the first contact indicator; and
a selection controller configured to activate a point indicator within the object contact area away from the first contact indicator, the point indicator indicator configured to move within the object contact area in response to the movement of the first contact indicator, the point indicator indicator configured to be positioned over a target position to facilitate selection of target information for processing.

11. The system of claim 10, in which the object-sensing controller activates the first contact indicator in response to one of an object contacting the touch screen interface and sensing the object within a vicinity of the touch screen interface.

12. The system of claim 10, in which the first contact indicator comprises one of a pointer and a cursor.

13. The system of claim 10, in which the selection controller is configured to activate the point indicator in response to the activation of the first contact indicator.

14. The system of claim 11, in which a processing controller is configured to process the target information in response to a gesture command signal on the touch screen interface, with the object to activate the processing of the target information.

15. The system of claim 10, in which the object-sensing controller is configured to activate a second contact indicator away from the first contact indicator, the second contact indicator configured to be moved around to select the target information in reference to the target position.

16. The system of claim 15, in which the second contact indicator is configured to be moved one of angularly away and angularly toward the target position to select the target information in reference to the target position.

17. The system of claim 15, in which the second contact indicator is activated outside the object contact area.

18. The system of claim 11, in which the object-sensing conteoller is further configured to activate a geometrically shaped menu within the object contact area, in which the geometrically shaped menu is configured to provide navigation features to the touch screen device.

19. An apparatus for navigating a touch screen interface associated with a touch screen device comprising:
means for activating a first contact indicator within an object contact area on a touch screen interface of the touch screen device, the object contact area configured to move within the touch screen interface in response to movement of the first contact indicator;
means for activating a point indicator within the object contact area away from the first contact indicator, the point indicator configured to move within the object contact area in response to the movement of the first contact indicator;
means for positioning the point indicator over a target position associated with the touch screen interface; and
means for selecting a target information for processing, in whichthe target information is selected in reference to the target position.

20. The apparatus of claim 19, in which the means for means for activating a first contact indicator further comprises, means for activating a second contact indicator away from the first contact indicator, and moving the second contact indicator to select the target information in reference to the target position.
